(19) United States
(12) Patent Application Publication
(10) Pub. No.: US 2018/0065392 A1
(43) Pub. Date: Mar. 8, 2018

(54) LIGHT COLORED THERMALLY CONDUCTIVE POLYMER COMPOSITIONS WITH LASER MARKING FUNCTION

(71) Applicant: SABIC Global Technologies B.V., Bergen op Zoom (NL)

(72) Inventors: Tong WU, Shanghai (CN); Mingcheng GUO, Shanghai (CN); Jiwen WANG, Shanghai (CN); Xiaofeng YU, Shanghai (CN)

(21) Appl. No.: 15/551,808

(22) PCT Filed: Feb. 19, 2016
(86) PCT No.: PCT/IB2016/050916

§ 371 Date: Aug. 17, 2017

Related U.S. Application Data
(60) Provisional application No. 62/119,034, filed on Feb. 20, 2015.

(51) Int. Cl. B41M 5/26; C08L 77/02; C08L 77/06; C08L 79/08; C08K 3/22; C08K 3/32; C08K 9/06

(52) U.S. Cl. CPC B41M 5/267; C08L 77/02; C08L 77/06; C08L 79/08; C08K 2003/328; C08K 3/32; C08K 9/06; C08K 2003/2241; C08K 2003/2248; C08K 3/22

(57) ABSTRACT

The disclosure concerns polymer compositions exhibiting thermal conductivity and laser marking properties while maintaining mechanical properties and a light color throughout the composition.

### RELATED APPLICATION

The present application claims priority to U.S. patent application 62/119,034, filed Feb. 20, 2015, the entirety of which application is incorporated herein by reference for any and all purposes.

### TECHNICAL FIELD

The disclosure concerns resin compositions with laser marking properties and improved mechanical properties, as well as sufficient pigmentation for light coloring.

### BACKGROUND

Laser marking refers to the application of laser irradiation to a substrate surface to visibly alter the irradiated area. The presence of a laser marking additive in the substrate creates this discernible change in the irradiated, and hence “marked,” area. The laser causes a distinct contrast between the laser-marked region and the unmarked region of the substrate. In plastics, such laser marking methods can be used to deliver text, brand logos, barcodes, or other identifiers. As the laser can achieve resolutions of less than 0.1 millimeters (mm), laser marking technology has become a precise, reliable, and highly reproducible means of imprinting a substrate without degrading the substrate. Given these advantages, laser marking has been employed in light emitting diode (LED) heat sinks, electronic semi-conductors and other heat-emitting devices. In these heat generating devices, high thermal conductivity is also required for an improved heat dissipation and an overall increase in the operational life span of the devices.

### SUMMARY

Laser marking additives can be often dark in color which can thereby restrict the coloring of a substrate material to a black or a dark hue. It would be beneficial to provide a composition that can broaden the color capability of laser marked materials to include light colored compositions and that can readily incorporate thermally conductive additives while maintaining mechanical properties.

The present disclosure relates to compositions comprising a polymer base resin, a laser marking additive, and a thermally conductive additive. The present disclosure further relates to compositions comprising a polymer base resin, a laser marking additive, and a thermally conductive additive wherein the composition is light colored or contains sufficient pigment to establish a light color throughout the composition.

Furthermore, the present disclosure relates to a method of forming a composition comprising combining a polymer base resin, a laser marking additive, and a thermally conductive additive.

In one aspect, the disclosure relates to a method of forming an article comprising the steps of molding an article from the composition described herein.

### DETAILED DESCRIPTION

Laser marking compositions have useful applications across a variety of fields. To be useful in the electronics field, laser-marking compositions should be thermally conductive. As the array of appropriate applications grows, the aesthetic versatility of these laser-marking compositions is increasingly important. However, laser-marking additives can typically be dark colored which can often impart a darker hue for the polymer resin to which the additive is added. The thermoplastic compositions of the present disclosure provide thermally conductive, laser-marking function materials that can also be light colored.

The present disclosure relates to a composition comprising a polymer base resin, a laser marking additive, and a thermally conductive additive, wherein the composition is light colored or contains sufficient pigment to establish a light color throughout the composition. In a further aspect, the composition exhibits good thermal conductivity.

In an aspect, the composition can comprise from 29.05 weight percent (wt. %) to about 90 wt. % of a polymer base resin, from 9 wt. % to 70 wt. % of a thermally conductive filler, and from 0.05 wt. % to 40 wt. % of a laser marking additive, wherein the combined weight percent value of all components does not exceed about 100 wt. %, wherein all weight percent values are based on the total weight of the composition, and wherein the composition exhibits a thermal conductive performance with through-plane thermal conductivity of from at least 0.4 watts per meter Kelvin (W/m·K) to 5 W/m·K, wherein an intensity variation of at least 40 is observed between a laser-marked region and a non-marked region of the composition according to a standard calibration wherein an observed intensity at a value of 0 corresponds to black and an observed intensity at a value of 255 corresponds to white, and wherein the laser marking is visibly discernible.

In a further aspect, the composition can comprise from about 29.05 weight percent (wt. %) to about 90 wt. % of a polymer base resin, from about 9 wt. % to about 70 wt. % of a thermally conductive filler, and from about 0.05 wt. % to about 40 wt. % of a laser marking additive, wherein the combined weight percent value of all components does not exceed about 100 wt. %, wherein all weight percent values are based on the total weight of the composition, and wherein the composition exhibits a thermal conductive performance with through-plane thermal conductivity of from at least about 0.4 watts per meter Kelvin (W/m·K) to about 5 W/m·K, wherein an intensity variation of at least 40 is observed between a laser-marked region and a non-marked region of the composition according to a standard calibration wherein an observed intensity at a value of 0 corresponds to black and an observed intensity at a value of 255 corresponds to white, and wherein the laser marking is visibly discernible.

### Polymer Base Resin

In an aspect, the composition can comprise a polymer base resin. In various aspects, the polymer base resin can comprise a thermoplastic resin or a thermoset resin. The thermoplastic resin can comprise polypropylene, polyethylene, ethylene based copolymer, polycarbonate, polyamide, polyester, polyoxymethylene (POM), polybutylene terephthalate (PBT), polyethylene terephthalate (PET), polycyclohexylendimethylene terephthalate (PCT), liquid crystal polymers (LPC), polyphenylene sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), and combinations thereof. The thermoplastic resin can also include thermoplastic elastomers such as polyamide and polyester based elastomers. The polymer base resin can also comprise blends and/or other types of combination of resins described above. In various aspects, the polymer base resin can also comprise a thermosetting polymer. Appropriate thermosetting resins can include phenol resin, urea resin, melamine-formaldehyde resin, urea-formaldehyde latex, xylene resin, diallyl phthalate resin, epoxy resin, aniline resin, furan resin, polyurethane, or combinations thereof.

As used herein, “polycarbonate” can refer to a polymer having repeating structural carbonate units of formula (1):

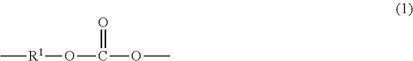

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In some aspects, one atom separates A¹ from A². Specifically, each R¹ can be derived from a bisphenol of formula (3)

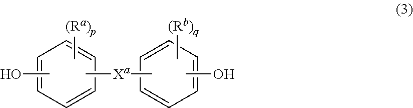

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (specifically para in some embodiments) to each other on the C₆ arylene group. In an aspect, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. In an aspect, p and q is each 1, and R^{a} and R^{b} are each a C₁₋₃ alkyl group, specifically methyl, disposed meta to the hydroxy group on each arylene group.

Other useful dihydroxy compounds of the formula HO—R¹—OH can include aromatic dihydroxy compounds of formula (4)

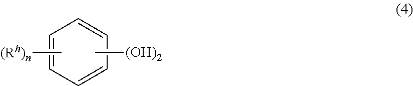

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen can be bromine.

Some illustrative examples of specific dihydroxy compounds can include, but are not limited to the following: bisphenols, resorcinol, substituted resorcinol compounds such as 5-methyl resorcinol, 5-ethyl resorcinol, 5-propyl resorcinol, 5-butyl resorcinol, substituted hydroquinones such as 2-methyl hydroquinone, 2-ethyl hydroquinone, 2-propyl hydroquinone, hydroquinone, or the like, or combinations comprising at least one of the foregoing dihydroxy compounds.

Specific examples of bisphenol compounds of formula (3) can include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In a specific embodiment, the polycarbonate is a linear homopolymer derived from bisphenol A, in which each of A1 and A2 is p-phenylene and Y1 is isopropylidene in formula (3).

“Polycarbonates” can include homopolycarbonates (wherein each R1 in the polymer is the same), copolymers comprising different R1 moieties in the carbonate (“copolycarbonates”), and copolymers comprising carbonate units and other types of polymer units, such as ester units or siloxane units.

A specific type of copolymer is a poly(ester-carbonate), also known as a polyester-polycarbonate. Such copolymers further contain, in addition to recurring carbonate units of formula (1), repeating units of formula (5)

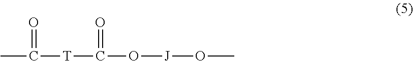

wherein J is a divalent group derived from a dihydroxy compound (including a reactive derivative thereof), and can be, for example, a C₂₋₁₀ alkylene, a C₆₋₂₀ cycloalkylene, a C₆₋₂₀ arylene, or a polyoxyalkylene in which the alkylene groups contain 2 to 6 carbon atoms, specifically 2, 3, or 4 carbon atoms; and T is a divalent group derived from a dicarboxylic acid (including a reactive derivative thereof), and can be, for example, a C₂₋₂₀ alkylene, a C₆₋₂₀ cycloalkylene, or a C₆₋₂₀ arylene. Copolyesters containing a combination of different T and/or J groups can be used. The polyester units can be branched or linear.

In an aspect, J can be a C2-30 alkylene group having a straight chain, branched chain, or cyclic (including polycyclic) structure, for example ethylene, n-propylene, i-propylene, 1,4-butylene, 1,6-cyclohexylene, or 1,4-methylenecyclohexane. In another embodiment, J can be derived from a bisphenol of formula (3), e.g., bisphenol A. In another embodiment, J can be derived from an aromatic dihydroxy compound of formula (6), e.g., resorcinol.

Aromatic dicarboxylic acids that can be used to prepare the polyester units can include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Specific dicarboxylic acids include terephthalic acid, isophthalic acid, naphthalene dicarboxylic acid, 1,4-cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is 91:9 to 2:98.

Specific ester units include ethylene terephthalate, n-propylene terephthalate, n-butylene terephthalate, 1,4-cyclohexanedimethylene terephthalate, and ester units derived from isophthalic acid, terephthalic acid, and resorcinol (ITR)). The molar ratio of ester units to carbonate units in the copolymers can vary broadly, for example 1:99 to 99:1, specifically 10:90 to 90:10, more specifically 25:75 to 75:25, or 2:98 to 15:85, depending on the desired properties of the final composition. Specific poly(ester-carbonate)s are those including bisphenol A carbonate units and isophthalate-terephthalate-bisphenol A ester units, also commonly referred to as poly(carbonate-ester)s (PCE) poly(phthalate-carbonate)s (PPC) depending on the molar ratio of carbonate units and ester units.

In a specific embodiment, the polycarbonate copolymer is a poly(bisphenol A carbonate)-co-(bisphenol A-phthalate-ester) of formula (6a)

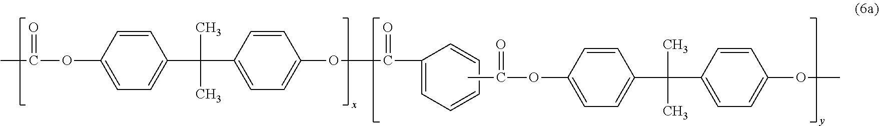

wherein y and x represent the weight percent of arylate-bisphenol A ester units and bisphenol A carbonate units, respectively. Generally, the units are present as blocks. In an embodiment, the weight percent of ester units y to carbonate units x in the copolymers is 50:50 to 99:1, or 55:45 to 90:10, or 75:25 to 95:5. Copolymers of formula (8a) comprising 35 to 45 wt. % of carbonate units and 55 to 65 wt. % of ester units, wherein the ester units have a molar ratio of isophthalate to terephthalate of 45:55 to 55:45 are often referred to as poly(carbonate-ester)s (PCE) and copolymers comprising 15 wt. % to 25 wt. % of carbonate units and 75 wt. % to 85 wt. % of ester units having a molar ratio of isophthalate to terephthalate from 98:2 to 88:12 are often referred to as poly(phthalate-carbonate)s (PPC).

In another aspect, a specific polycarbonate copolymer can be a poly(carbonate)-co-(monoaryl arylate ester) containing carbonate units (1) and repeating monoaryl arylate ester units of formula (5b)

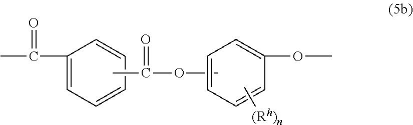

wherein each R^{h} is independently a halogen atom, a C₁₋₁₀hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. Specifically, each R^{h} is independently a C₁₋₄ alkyl, and n is 0 to 3, 0 to 1, or 0. These poly(carbonate)-co-(monoaryl arylate ester) copolymers are of formula (6b)

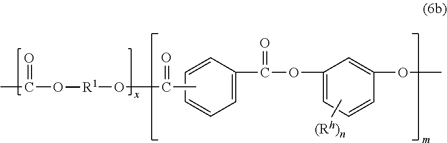

wherein R¹ is as defined in formula (1) and R^{h}, and n are as defined in formula (5b), and the mole ratio of x:m is 99:1 to 1:99, specifically 80:20 to 20:80, or 60:40 to 40:60.

Specifically, the monoaryl-arylate ester unit (5b) can be derived from the reaction of a combination of isophthalic and terephthalic diacids (or derivatives thereof) with resorcinol (or reactive derivatives thereof) to provide isophthalate-terephthalate-resorcinol (“ITR” ester units) of formula (5c)

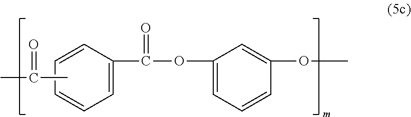

wherein m is 4 to 100, 4 to 90, 5 to 70, more specifically 5 to 50, or still more specifically 10 to 30. In an aspect, the ITR ester units can be present in the polycarbonate copolymer in an amount greater than or equal to 95 mol %, specifically greater than or equal to 99 mol %, and still more specifically greater than or equal to 99.5 mol % based on the total moles of ester units in the copolymer. Such (isophthalate-terephthalate-resorcinol)-carbonate copolymers (“ITR-PC”) can possess many desired features, including toughness, transparency, and weatherability. ITR-PC copolymers can also have desirable thermal flow properties. In addition, ITR-PC copolymers can be readily manufactured on a commercial scale using interfacial polymerization techniques, which allow synthetic flexibility and composition specificity in the synthesis of the ITR-PC copolymers.

A specific example of a poly(carbonate)-co-(monoaryl arylate ester) can be a poly(bisphenol A carbonate)-co-(isophthalate-terephthalate-resorcinol ester) of formula (6c)

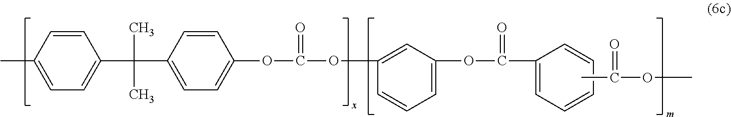

wherein m is 4 to 100, 4 to 90, 5 to 70, more specifically 5 to 50, or still more specifically 10 to 30, and the mole ratio of x:m is 99:1 to 1:99, specifically 90:10 to 10:90. The ITR ester units are present in the poly(carbonate-arylate ester) copolymer in an amount greater than or equal to 95 mol %, specifically greater than or equal to 99 mol %, and still more specifically greater than or equal to 99.5 mol % based on the total moles of ester units. Other carbonate units, other ester units, or a combination thereof can be present, in a total amount of 1 to 20 mole % based on the total moles of units in the copolymers, for example resorcinol carbonate units of formula (9) and bisphenol ester units of formula (7a):

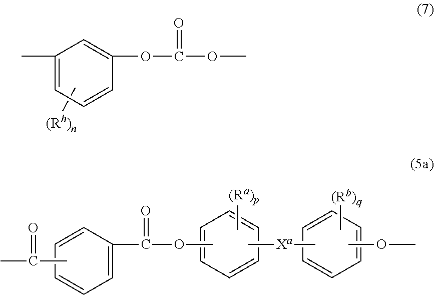

wherein, in the foregoing formulae, R^{h} is each independently a C₁₋₁₀ hydrocarbon group, n is 0 to 4, R^{a} and R^{b} are each independently a C₁₋₁₂ alkyl, p and q are each independently integers of 0 to 4, and X^{a} is a single bond, —O—, —S—, —S(O)—, —S(O)₂—, —C(O)—, or a C₁₋₁₃ alkylidene of formula —C(R^{c})(R^{d})— wherein R^{c} and R^{d} are each independently hydrogen or C₁₋₁₂ alkyl, or a group of the formula —C(═R^{e})— wherein R^{e} is a divalent C₁₋₁₂ hydrocarbon group. The bisphenol ester units can be bisphenol A phthalate ester units of the formula (8)

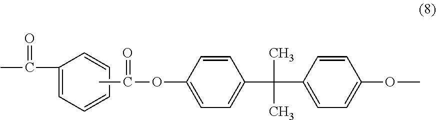

In one aspect, poly(bisphenol A carbonate)-co-(isophthalate-terephthalate-resorcinol ester) (6c) can comprise 1 to 20 mol % of bisphenol A carbonate units, 20-98 mol % of isophthalic acid-terephthalic acid-resorcinol ester units, and optionally 1 to 60 mol % of resorcinol carbonate units, isophthalic acid-terephthalic acid-bisphenol A phthalate ester units, or a combination thereof.

The polycarbonate copolymers comprising arylate ester units can have an M_{w} of 2,000 to 100,000 g/mol, specifically 3,000 to 75,000 g/mol, more specifically 4,000 to 50,000 g/mol, more specifically 5,000 to 35,000 g/mol, and still more specifically 17,000 to 30,000 g/mol. Molecular weight determinations may be performed using GPC using a cross linked styrene-divinyl benzene column, at a sample concentration of 1 milligram per milliliter, and as calibrated with polycarbonate standards. Samples are eluted at a flow rate of 1.0 ml/min with methylene chloride as the eluent.

A specific example of a poly(ester-carbonate) is a poly(aliphatic ester-carbonate derived from a linear C₆₋₂₀ aliphatic dicarboxylic acid (which includes a reactive derivative thereof), specifically a linear C₆-C₁₂ aliphatic dicarboxylic acid(which includes a reactive derivative thereof). Specific dicarboxylic acids include n-hexanedioic acid (adipic acid), n-decanedioic acid (sebacic acid), and alpha, omega-C₁₂ dicarboxylic acids such as dodecanedioic acid (DDDA). A specific poly(aliphatic ester)-polycarbonate is of formula (9):

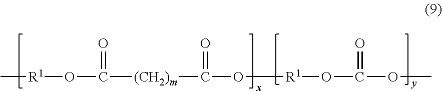

wherein each R¹ can be the same or different, and is as described in formula (1), m is 4 to 18, specifically 4 to 10, and the average molar ratio of ester units to carbonate units x:y is 99:1 to 1:99, including 13:87 to 2:98, or 9:91 to 2:98, or 8:92 to 2:98. In a specific embodiment, the poly(aliphatic ester)-polycarbonate copolymer comprises bisphenol A sebacate ester units and bisphenol A carbonate units, having, for example an average molar ratio of x:y of 2:98 to 8:92, for example 6:94. Such poly(aliphatic ester-carbonate)s are commercially available as LEXAN™ HFD from the Innovative Plastics Division of SABIC (LEXAN™ is a trademark of SABIC IP B. V.). The poly(aliphatic ester-carbonate) can have a weight average molecular weight of 15,000 to 40,000 Daltons, including 20,000 to 38,000 Daltons (measured by GPC based on BPA polycarbonate standards).

In addition to the polycarbonates described above, combinations of the polycarbonate with other thermoplastic polymers, for example combinations of homopolycarbonates, copolycarbonates, and polycarbonate copolymers with polyesters, can be used. Useful polyesters include, for example, polyesters having repeating units of formula (7), which include poly(alkylene dicarboxylates), liquid crystalline polyesters, and polyester copolymers. The polyesters described herein can generally be completely miscible with the polycarbonates when blended.

Useful polyesters can include aromatic polyesters, poly(alkylene esters) including poly(alkylene arylates), and poly(cycloalkylene diesters). Aromatic polyesters can have a polyester structure according to formula (5), wherein J and T are each aromatic groups as described above. In an embodiment, useful aromatic polyesters can include poly(isophthalate-terephthalate-resorcinol) esters, poly(isophthalate-terephthalate-bisphenol A) esters, poly[(isophthalate-terephthalate-resorcinol) ester-co-(isophthalate-terephthalate-bisphenol A)] ester, or a combination comprising at least one of these. Also contemplated are aromatic polyesters with a minor amount, e.g., 0.5 to 10 wt. %, based on the total weight of the polyester, of units derived from an aliphatic diacid and/or an aliphatic polyol to make copolyesters. Poly(alkylene arylates) can have a polyester structure according to formula (5), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups J include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(n-propylene terephthalate) (PPT). Also useful are poly(alkylene naphthoates), such as poly(ethylene naphthanoate) (PEN), and poly(butylene naphthanoate) (PBN). A specifically useful poly(cycloalkylene diester) is poly(1,4-cyclohexanedimethylene terephthalate) (PCT). Combinations comprising at least one of the foregoing polyesters can also be used.

Copolymers comprising alkylene terephthalate repeating ester units with other ester groups can also be useful. Specifically useful ester units can include different alkylene terephthalate units, which can be present in the polymer chain as individual units, or as blocks of poly(alkylene terephthalates). Copolymers of this type include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

The composition can further comprise a polysiloxane-polycarbonate copolymer, also referred to as a poly(siloxane-carbonate). The polydiorganosiloxane (also referred to herein as “polysiloxane”) blocks comprise repeating diorganosiloxane units as in formula (10)

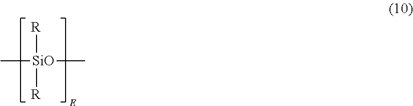

wherein each R is independently a C₁₋₁₃ monovalent organic group. For example, R can be a C₁-C₁₃ alkyl, C₁-C₁₃ alkoxy, C₂-C₁₃ alkenyl, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

A combination of a first and a second (or more) polycarbonate-polysiloxane copolymers can be used, wherein the average value of E of the first copolymer is less than the average value of E of the second copolymer.

In an aspect, the polydiorganosiloxane blocks are of formula (11)

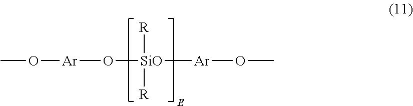

wherein E is as defined above; each R can be the same or different, and is as defined above; and Ar can be the same or different, and is a substituted or unsubstituted C₆-C₃₀ arylene, wherein the bonds are directly connected to an aromatic moiety. Ar groups in formula (11) can be derived from a C₆-C₃₀ dihydroxyarylene compound. Dihydroxyarylene compounds include 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-l-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing dihydroxy compounds can also be used.

In another aspect, polydiorganosiloxane blocks can be of formula (12)

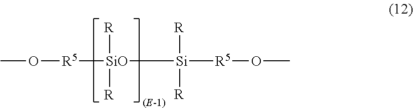

wherein R and E are as described above, and each R⁵ is independently a divalent C₁-C₃₀ organic group, and wherein the polymerized polysiloxane unit is the reaction residue of its corresponding dihydroxy compound. In one aspect, the polydiorganosiloxane blocks are of formula (15):

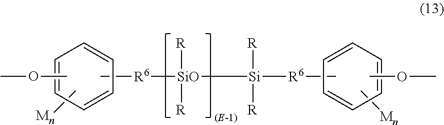

wherein R and E are as defined above. R⁶ in formula (13) is a divalent C₂-C₈ aliphatic. Each M in formula (13) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, R is methyl, M is methoxy, n is one, R⁶ is a divalent C₁-C₃ aliphatic group. Specific polydiorganosiloxane blocks are of the formula

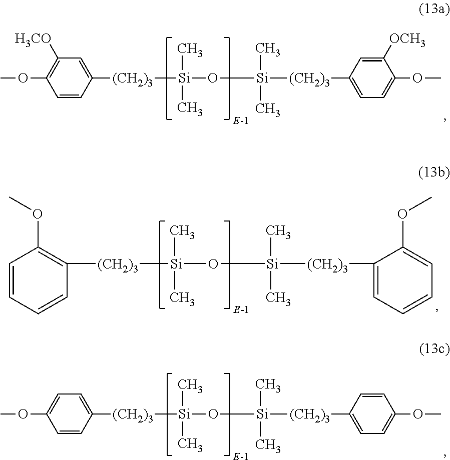

or a combination comprising at least one of the foregoing, wherein E has an average value of 2 to 200, 2 to 125, 5 to 125, 5 to 100, 5 to 50, 20 to 80, or 5 to 20.

Blocks of formula (13) can be derived from the corresponding dihydroxy polydiorganosiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The polysiloxane-polycarbonate copolymers can then be manufactured, for example, by the synthetic procedure of European Patent Application Publication No. 0524 731A1 of Hoover, page 5, Preparation 2.

Transparent polysiloxane-polycarbonate copolymers can comprise carbonate units (1) derived from bisphenol A, and repeating siloxane units (13a), (13b), (13c), or a combination comprising at least one of the foregoing (specifically of formula 13a), wherein E has an average value of 4 to 50, 4 to 15, specifically 5 to 15, more specifically 6 to 15, and still more specifically 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(siloxane-carbonate) copolymers.

The polysiloxane-polycarbonate copolymers can comprise 50 wt. % to 99 wt. % of carbonate units and 1 wt. % to 50 wt. % siloxane units. Within this range, the polyorganosiloxane-polycarbonate copolymer can comprise 70 wt. %, to 98 wt. %, more specifically 75 wt. % to 97 wt. % of carbonate units and 2 wt. % to 30 wt. %, more specifically 3 wt. % to 25 wt. % siloxane units.

In some aspects, a blend can be used, in particular a blend of a bisphenol A homopolycarbonate and a polysiloxane-polycarbonate block copolymer of bisphenol A blocks and eugenol capped polydimethylsilioxane blocks, of the formula (14)

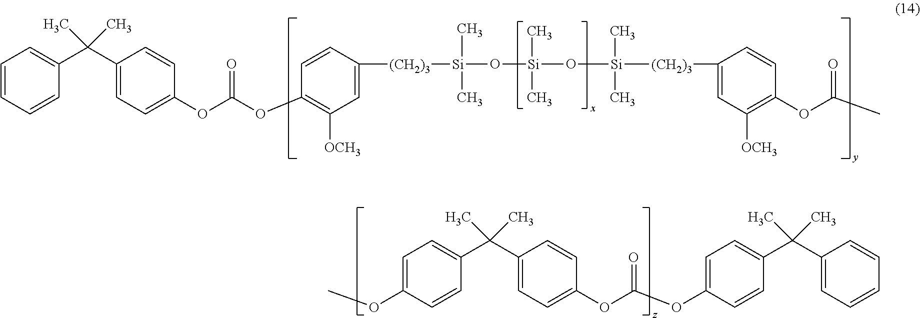

wherein x is 1 to 200, specifically 5 to 85, specifically 10 to 70, specifically 15 to 65, and more specifically 40 to 60; xis 1 to 500, or 10 to 200, and z is 1 to 1000, or 10 to 800. In an embodiment, x is 1 to 200, y is 1 to 90 and z is 1 to 600, and in another embodiment, x is 30 to 50, y is 10 to 30 and z is 45 to 600. The polysiloxane blocks may be randomly distributed or controlled distributed among the polycarbonate blocks.

In one aspect, the polysiloxane-polycarbonate copolymer can comprise 10 wt % or less, specifically 6 wt % or less, and more specifically 4 wt % or less, of the polysiloxane based on the total weight of the polysiloxane-polycarbonate copolymer, and can generally be optically transparent and are commercially available under the designation EXL-T from SABIC. In another aspect, the polysiloxane-polycarbonate copolymer can comprise 10 wt % or more, specifically 12 wt % or more, and more specifically 14 wt % or more, of the polysiloxane copolymer based on the total weight of the polysiloxane-polycarbonate copolymer, are generally optically opaque and are commercially available under the trade designation EXL-P from SABIC.

Polyorganosiloxane-polycarbonates can have a weight average molecular weight of 2,000 Daltons to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards.

The polyorganosiloxane-polycarbonates can have a melt volume flow rate, measured at 300° C./1.2 kg, of 1 to 50 cubic centimeters per 10 minutes (cm³/10 min), specifically 2 to 30 cm³/10 min. Mixtures of polyorganosiloxane-polycarbonates of different flow properties can be used to achieve the overall desired flow property.

The disclosed compositions can comprise polyesters as the polymer base resin. Polyester resins can include crystalline polyester resins such as polyester resins derived from at least one diol, and at least one dicarboxylic acid. Preferred polyesters have repeating units according to structural formula (15)

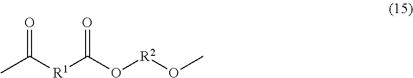

wherein, R¹ and R² are independently at each occurrence a aliphatic, aromatic and cycloaliphatic radical. In one embodiment R2 is an alkyl radical compromising a dehydroxylated residue derived from an aliphatic or cycloaliphatic diol, or mixtures thereof, containing from 2 to 20 carbon atoms, or to about 20 carbon atoms, and R¹ is an aromatic radical comprising a decarboxylated residue derived from an aromatic dicarboxylic acid. The polyester is a condensation product where R² is the residue of an aromatic, aliphatic or cycloaliphatic radical containing diol having C1 to C30 carbon atoms or chemical equivalent thereof, and R¹ is the decarboxylated residue derived from an aromatic, aliphatic or cycloaliphatic radical containing diacid of C1 to C30 carbon atoms or chemical equivalent thereof. The polyester resins are typically obtained through the condensation or ester interchange polymerization of the diol or diol equivalent component with the diacid or diacid chemical equivalent component.

Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred from the standpoint of cost. Also, to the extent that the effects of this invention are not lost, other bifunctional carboxylic acids such as aliphatic dicarboxylic acids such as oxalic acid, malonic acid, adipic acid, suberic acid, azelaic acid, sebacic acid, decane dicarboxylic acid, and cyclohexane dicarboxylic acid; and their ester-modified derivatives can also be used.

In an aspect, commonly used diols can be used herein without difficulty, for example, straight chain aliphatic and cycloaliphatic diols having 2 to 15 carbon atoms, for further example, ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc.; polyethylene glycol; bivalent phenols such as dihydroxydiarylalkanes such as 2,2-bis(4-hydroxylphenyl)propane that can be called bisphenol-A, bis(4-hydroxyphenyl) methane, bis(4-hydroxyphenyl)naphthylmethane, bis(4-hydroxyphenyl)phenylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane, and 2,2-bis(4-hydroxyphenyl)-1,1,1,3,3,3-hexafluoropropane; dihyroxydiarylcycloalkanes such as 1,1-bis(4-hydroxyphenyl)cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′,5,5′-tetramethyl-4,4-diydroxybenzophenone; dihydroxydiaryl sulfides such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides such as bis(4-hydroxyphenyl)sulfoxide; dihydroxydiphenyls such as 4,4′-dihydroxyphenyl; dihydroxyarylfluorenes such as 9,9-bis(4-hydroxyphenyl)fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more kinds of diols can be combined as needed.

In a specific aspect, the polyester can be polyethylene terephthalate, polybutylene terephthalate, polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters. Polyethylene terephthalate (PET) and polybutylene terephthalate (PBT) are particularly suitable as polyesters that are obtained by the polymerization of these kinds of bifunctional carboxylic acid and diol ingredients.

Polyester base resin compositions of the present disclosure can be a single kind of polyester used alone, or two or more kinds used in combination. Furthermore, copolyesters can also be used as needed.

In an aspect, polyetherimides can be used in the disclosed compositions and can be of formula (16):

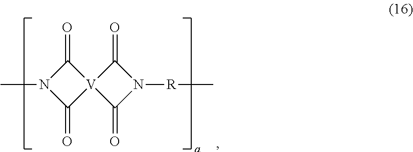

wherein a is more than 1, for example 10 to 1,000 or more, or more specifically 10 to 500.

The group V in formula (16) is a tetravalent linker containing an ether group (a “polyetherimide” as used herein) or a combination of an ether groups and arylenesulfone groups (a “polyetherimidesulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups; and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Suitable additional substitutions include, but are not limited to, ethers, amides, esters, and combinations comprising at least one of the foregoing.

The R group in formula (16) can include but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (17):

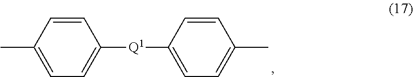

wherein Q1 includes but is not limited to a divalent moiety such as —O—, —O—, —C(O)—, —SO₂—, —SO—, —C_{y}H_{2y}— (y being an integer from 1 to 5), and halogenated derivatives thereof, including perfluoroalkylene groups.

In an aspect, linkers V can include but are not limited to tetravalent aromatic groups of formula (18):

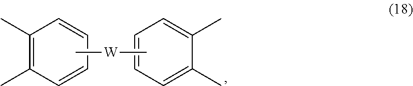

wherein W is a divalent moiety including —O—, —SO₂—, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (19):

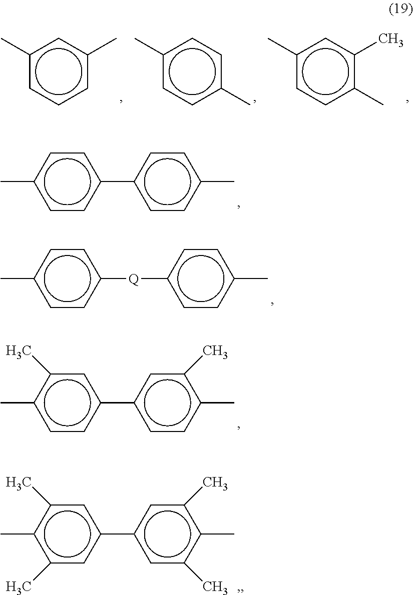

wherein Q can include, but is not limited to a divalent moiety including —O—, —S—, —C(O), —SO₂—, —SO—, —C_{y}H_{2y}— (y being an integer from 1 to 5), and halogenated derivatives thereof, including perfluoroalkylene groups.

In an aspect, the polyetherimide comprise more than 1, specifically 10 to 1,000, or more specifically, 10 to 500 structural units, of formula (20):

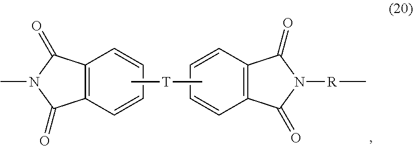

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (16) as defined above; and R is a divalent group of formula (16) as defined above.

In another aspect, the polyetherimidesulfones can be polyetherimides comprising ether groups and sulfone groups wherein at least 50 mole % of the linkers V and the groups R in formula (1) comprise a divalent arylenesulfone group. For example, all linkers V, but no groups R, can contain an arylenesulfone group; or all groups R but no linkers V can contain an arylenesulfone group; or an arylenesulfone can be present in some fraction of the linkers V and R groups, provided that the total mole fraction of V and R groups containing an aryl sulfone group is greater than or equal to 50 mole %.

Even more specifically, polyetherimidesulfones can comprise more than 1, specifically 10 to 1,000, or more specifically, 10 to 500 structural units of formula (21):

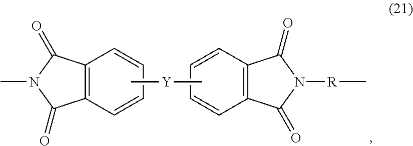

wherein Y is —O—, —SO₂—, or a group of the formula —O—Z—O— wherein the divalent bonds of the —O—, SO₂—, or the —O—Z—O— group are in the 3,3′, 3,4′, 4,3′, or the 4,4′ positions, wherein Z is a divalent group of formula (16) as defined above and R is a divalent group of formula (16) as defined above, provided that greater than 50 mole % of the sum of moles Y+moles R in formula (14) contain —SO₂— groups.

It is to be understood that the polyetherimides and polyetherimidesulfones can optionally comprise linkers V that do not contain ether or ether and sulfone groups, for example linkers of formula (22):

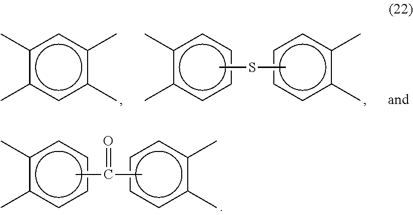

Imide units containing such linkers can generally be present in amounts ranging from 0 to 10 mole % of the total number of units, specifically 0 to 5 mole %. In one embodiment no additional linkers V are present in the polyetherimides and polyetherimidesulfones.

The polyetherimide resin can have a weight average molecular weight (Mw) within a range having a lower limit and/or an upper limit. The range can include or exclude the lower limit and/or the upper limit. The polyetherimide resin can have a molecular weight from 5,000 Daltons to 110,000 Daltons, or from about 5,000 Daltons to about 110,000 Daltons. For example, the polyetherimide resin can have a weight average molecular weight (Mw) from 5,000 to 100,000 Daltons, from 5,000 to 80,000 Daltons, or from 5,000 to 70,000 Daltons. In a further example, the polyetherimide resin can have a weight average molecular weight (Mw) from about 5,000 to about 100,000 Daltons, from about 5,000 to about 80,000 Daltons, or from about 5,000 to about 70,000 Daltons. The primary alkyl amine modified polyetherimide will have lower molecular weight and higher melt flow than the starting, unmodified, polyetherimide.

The polyetherimide resin can be selected from the group consisting of a polyetherimide, for example, as described in U.S. Pat. Nos. 3,875,116, 6,919,422, and 6,355,723; a silicone polyetherimide, for example, as described in U.S. Pat. Nos. 4,690,997 and 4,808,686; a polyetherimidesulfone resin, as described in U.S. Pat. No. 7,041,773; or combinations thereof. Each of these patents are incorporated herein in their entirety.

The polyetherimide resin can have a glass transition temperature within a range having a lower limit and/or an upper limit. The range can include or exclude the lower limit and/or the upper limit. The polyetherimide resin can have a glass transition temperature of from 100° C. to 310° C., or from about 100° C. to about 310° C. For example, the polyetherimide resin can have a glass transition temperature (Tg) greater than 200° C. or greater than about 200° C. The polyetherimide resin can be substantially free (less than 100 parts per million, ppm) of benzylic protons. The polyetherimide resin can be free of benzylic protons. The polyetherimide resin can have an amount of benzylic protons below 100 ppm. In one aspect, the amount of benzylic protons ranges from more than 0 to below 100 ppm. In another aspect, the amount of benzylic protons is not detectable.

The polyetherimide resin can be substantially free (less than 100 ppm) of halogen atoms. The polyetherimide resin can be free of halogen atoms. The polyetherimide resin can have an amount of halogen atoms below 100 ppm. In one embodiment, the amount of halogen atoms range from more than 0 to below 100 ppm. In another embodiment, the amount of halogen atoms is not detectable.

In one aspect, the polymer base resin can comprise a polyamide polymer. In a further aspect, the polyamide polymer component can comprise a single polyamide or, alternatively, in another aspect can comprise a blend of two or more different polyamides. In one aspect, the polyamide polymer component can be nylon 6. In another aspect, the polyamide polymer component can be nylon 6,6. In another aspect, the polyamide polymer component can be a mixture of nylon 6 and nylon 6,6. The polyamide polymer component be present in the composition in an amount in the range of from 29.05 wt. % to 70 wt. %, or from about 29.05 wt. % to about 70 wt. % of the composition. In further aspects, the polyamide polymer can be present in an amount within any range derived from any two of the above values, including for example, an amount in the range of from 35 wt. % to 70 wt. %, or from about 35 wt. % to about 70 wt. %, or an amount in the range of from 30 wt. % to 60 wt. %, or from about 30 wt. % to about 60 wt. %. For example, the polyamide polymer component can be a mixture of nylon 6 and nylon 6,6 and be present from 30 wt. % to 50 wt. % or from about 30 wt. % to about 50 wt. % of the polyamide component. For example, the polymer base resin can comprise 20 wt. %, or about 20 wt. %, of nylon 6 and 15 wt. %, or about 15 wt. %, of nylon 6,6 of the total weight of the composition.

### Thermally Conductive Filler

In various aspects, the composition can comprise a thermally conductive filler. Moreover, the composition can comprise highly thermally conductive fillers, where the thermal conductivity is greater than or equal to 50 W/m·K. Examples of the high thermally conductive fillers can include, but are not limited to, AlN (aluminum nitride), Al₄C₃ (aluminum carbide), Al₂O₃ (Aluminum oxide), AlON (aluminum oxynitride)BN (boron nitride), MgSiN₂ (magnesium silicon nitride), SiC (Silicon carbide), Si₃N₄ (silicon nitride), ceramic-coated graphite, and combinations thereof. Other suitable high thermally conductive fillers include graphite, expanded graphite, graphene, carbon fiber, carbon nanotube (CNT), graphitized carbon black, or a combination thereof. Such fillers suitably have thermal conductivities of more than 50 W/m·K, or more than about 50 W/m·K. For example, the fillers may have thermal conductivities from 50 W/m·K to 60 W/m·K, from 50 W/m·K to 100 W/m·K, up to 100 W/m·K, up to 500 W/m·K, or greater. These fillers may have thermal conductivities from about 50 W/m·K to about 60 W/m·K, from about 50 W/m·K to about 100 W/m·K, up to about 100 W/m·K, up to about 500 W/m·K, or greater. It should be understood that the disclosed compositions can include one or more of the foregoing, but may also be free of one or more of the foregoing.

In a further aspect, the composition can comprise low thermal conductive fillers. Such fillers can have thermal conductivities in the range of from about 0.0001 30 W/m·K to about 30 W/m·K, or from about 10 W/m·K to about 20 W/m·K. In further examples, such fillers can have thermal conductivities in the range from 0.0001 30 W/m·K to 30 W/m·K, or from about 10 W/m·K to about 20 W/m·K. Exemplary low thermal conductive fillers can include ZnS (Zinc sulfide), CaO (Calcium oxide), MgO (Magnesium oxide), ZnO (Zinc oxide), or TiO₂ (Titanium dioxide), or a combination thereof.

The compositions can also include one or more thermally insulative fillers as additives. Such insulative fillers can have a thermal conductivity lower than 10 W/m·K. Appropriate insulative fillers can include H₂Mg₃(SiO₃)₄ (talc), CaCO₃ (calcium carbonate), Mg(OH)₂ (magnesium hydroxide), mica, BaO (barium oxide), γ-AlO(OH)) (Boehmite), α-AlO(OH)) (Diaspore), Al(OH)₃ (Gibbsite), BaSO₄ (barium osulfate), CaSiO₃ (wollastonite), ZrO₂ (zirconium oxide), SiO₂ (silicon oxide), glass bead, glass fiber, MgO.xAl₂O₃, CaMg(CO₃)₂, ceramic coated clay, and combinations thereof. In an example, the composition can comprise a thermally insulating filler having a thermal conductivity of less than 10 w/m·K such as aminosilane treated magnesium hydroxide. In a further example, the composition can comprise from 9 wt. % to 70 wt. %, or from about 9 wt. % to about 70 wt. % of an aminosilane treated magnesium hydroxide.

In an aspect, the composition can comprise a mixture of thermally conductive fillers. The composition can comprise a mixture of low thermally conductive fillers and insulative conductive fillers, the mixture comprising from 9 wt. % to 70 wt. %, for from about 9 wt. % to about 70 wt. % of the total weight of the composition. For example, the composition can comprise a magnesium hydroxide and a zinc sulfide filler mixture.

### Laser Marking Additive

In various aspects, the composition can comprise a laser marking additive. Examples of appropriate laser marking additives can include, but are not limited to, a metal oxide, a metal-oxide coated filler, and a heavy metal mixture oxide spinel, such as copper chromium oxide spinel; a copper salt, such as copper hydroxide phosphate copper phosphate, copper sulfate, cuprous thiocyanato; organic metal complexes, such as palladium/palladium-containing heavy metal complexes or copper complexes; or a combination including at least one of the foregoing laser marking additives. In a further aspect, the laser marking additive can be a metal oxide selected from a copper-containing metal oxide, a titanium-containing metal oxide, a tin-containing metal oxide, a zinc-containing metal oxide, a magnesium-containing metal oxide, an aluminum-containing metal oxide, a gold-containing metal oxide, and a silver-containing metal oxide, or a combination thereof.

In various aspects, the laser marking additive can be selected from a heavy metal mixture oxide spinel, a copper salt, or a combination including at least one of the foregoing laser direct structuring additives. In a further aspect, the laser marking additive can comprise a combination of copper chromium oxide and at least one additional additive selected from a heavy metal mixture oxide spinel, or a copper salt.

In a yet further aspect, the laser marking additive can be a copper-containing material. In a still further aspect, the copper-containing material can be copper hydroxide phosphate. In an example, the laser marking additive can comprise a modified copper hydroxide phosphate mixture. The mixture can comprise copper hydroxide phosphate, N, N-Hexan-1, 6-diylbis (3-(3, 5-di-tert-butyl-4-hydroxyphenyl) propionamid) and 1, 3, 5-triazine-2, 4, 6, (1H, 3H, 5H)-trione/1, 3, 5-triazine-2, 4, 6-triamine.

In certain aspects, the laser marking additive can be a metal-oxide coated filler such as antimony doped tin oxide coating on a mica substrate, a copper-containing metal oxide, a zinc-containing metal oxide, a tin-containing metal oxide, a magnesium-containing metal oxide, an aluminum-containing metal oxide, a titanium-containing metal oxide, a gold-containing metal oxide, and a silver-containing metal oxide, or a combination including at least one of the foregoing metal oxides, and the substrate may be any other mineral, such as silica.

In an aspect, the laser marking additive can be present in an amount from 0.5 wt. % to 40 wt. %, or from about 0.5 wt. % to about 40 wt. % of the thermoplastic composition. In an example, the laser marking additive can be present in an amount from 0.5 wt. % to 15 wt. %, or from about 0.5 wt. % to about 15 wt. %. In further aspects, the laser marking additive can be present in an amount within any range derived from any two of the above values. For example, the laser marking additive can comprise a copper hydroxide phosphate, N, N-Hexan-1, 6-diylbis (3-(3, 5-di-tert-butyl-4-hydroxyphenyl) propionamid) and 1, 3, 5-triazine-2, 4, 6, (1H, 3H, 5H)-trione/1, 3, 5-triazine-2, 4, 6-triamine mixture in an amount of from 0.5 wt. % to 5 wt. %, or from about 0.5 wt. % to about 5 wt. %. In a further example, the laser marking additive comprising a copper hydroxide mixture can be present in the composition in an amount of up to 1 wt. % of the total weight of the composition.

In certain aspects, the present disclosure can also relate to light colored compositions capable of a laser marking function. The compositions can comprise a white color pigment to allow for a light color apparent throughout the composition. In an aspect, the white color pigment can be titanium dioxide. Titanium dioxide can also function as the laser marking additive of the composition. In an example, titanium dioxide can be present in the composition as a laser marking additive in an amount of from 0.5 wt. % to 15 wt. %, or from about 0.5 wt. % to about 15 wt. %.

### Additives

The composition can further comprise other additives. Exemplary additives can include ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, and metals, and combinations thereof.

Heat stabilizer additives can include organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. For example, the composition can comprise tris(2,4-di-tert-butylphenyl) phosphite. In another example, the composition can comprise 1-ethylpiperidine hypophosphite.

The composition can further comprise a reinforcing filler. Reinforcing fillers can include, but are not limited to, mica, clay, feldspar, flue dust, fillite, quartz, quartzite, perlite, tripoli, diatomaceous earth, carbon black, or the like, or combinations including at least one of the foregoing fillers or reinforcing agents. In an aspect, the reinforcing filler can be organic or inorganic. Organic reinforcing fillers can include organic polymers capable of forming fibers including but not limited to poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol). Exemplary inorganic fillers can include clay; titanium dioxide; fibers comprising asbestos or the like fibers; silicates and silica powders, aluminum silicate (mullite), synthetic calcium silicate, zirconium silicate, fused silica, crystalline silica graphite, natural silica sand, or the like; boron powders, boron-nitride powder, boron-silicate powders, or the like; alumina; magnesium oxide (magnesia); calcium sulfate (as its anhydride, dihydrate or trihydrate); calcium carbonates, talc, wollastonite, glass spheres, silicate spheres, cenospheres, aluminosilicate (armospheres),or the like; kaolin, single crystal fibers or “whiskers,” sulfides, barium compounds, metals and metal oxides, flaked fillers, fibrous fillers, natural fillers and reinforcements.

In one aspect, the composition can comprise an inorganic filler. The inorganic filler can comprise glass fibers or glass spheres. For example, the filler can comprise glass spheres of an average diameter of 9 μm to 13 μm. As a further example, the composition can comprise from 8 wt. % to 15 wt. %, or from about 8 wt. % to about 15 wt. % of glass fiber or glass spheres as a reinforcing filler.

### Properties and Articles

In various aspects of the present disclosure, the thermoplastic compositions provide thermally conductive materials exhibiting laser-marking function that is readily discernible to a viewer. As used herein, readily discernible to a casual viewer refers to the ability to observe the laser marked regions of a given polymer against the unmarked regions of the same polymer with the naked eye.

The compositions of the present disclosure can exhibit good thermal conductivity as well as improvements in other mechanical properties. The composition can exhibit a through plane thermal conductivity of from 0.4 w/m·K to 5 w/m·K, or from about 0.4 w/m·K to about 5 w/m·K when tested in accordance with ASTM E1461. In an aspect, the compositions can exhibit a notched Izod impact strength of from at least 30 J/m to 40 J/m, or from at least about to 30 J/m to about 40 J/m at 23° C. when tested according to ASTM D256. The compositions can have an unnotched Izod impact strength of from 350 J/m to 550 J/m, or from about 350 J/m to about 550 J/m at 23° C. when tested according to ASTM D4812. In further aspects, the compositions can exhibit a modulus of 11,110 MPa to 11,800 MPa, or from about 11,110 MPa to about 11,800 MPa at 5 mm/min when tested in accordance with ASTM D638.

In an aspect, it is provided that the treatment of the disclosed compositions with laser irradiation having a wavelength of from 325 nm to 3370 nm, or from about 325 nm to about 3370 nm, (e.g., a He—Cd to HCN laser) can induce a reaction within the composition substrate to yield a discernibly marked region. In some aspects, the marked region can be discerned with the naked eye. In an example, samples of the resin composition disclosed herein containing a copper hydroxide phosphate laser marking additive can exhibit areas on the composition surface that are considerably darker where the composition has been laser irradiated. Laser irradiated areas of the composition can appear in the foreground against a lighter, or whiter, background corresponding to the regions of the composition that have not been laser irradiated. In a further example, laser marked regions can be visibly apparent as darker regions in a sample composition containing a laser marking pigment such as titanium dioxide. More specifically, in a disclosed composition containing 10 wt. % titanium dioxide, as a weight percent of the total composition, laser irradiated regions of the composition surface appear darker than the non-irradiated (or marked) regions of the background.

In various aspects, the marked region can be assessed according to a color calibration. The intensity variation between a marked region of the polymer base resin and an unmarked region can be observed according to a standard grayscale color calibration. For the standard calibration, white can be denoted an intensity value of 255 and black can be assigned an intensity value of 0. The calibration can be used to assess the intensity variation between a laser marked region and a non-laser marked region of the disclosed compositions. An intensity variation greater than 40 can indicate that the composition has been darkened where subjected to laser irradiation in comparison to a non-irradiated (or non-marked) region of the composition. The non-marked region is not darkened and remains a lighter color according to the color calibration. The laser marked region can thus be visibly discerned.

In various aspects, the disclosed compositions can utilize the advantage of laser marking can enable contact-free marking on irregular surfaces, or soft surfaces, or layered surfaces, or other surfaces that may not be readily marked otherwise. With the disclosed compositions, by means of example and with no intention to limit, a laser beam can provide a means of writing, inscribing a bar code, or applying a decorative mark. Laser-marking is also ink free (low cost), highly reproducible, and highly efficient. The foregoing advantages, as well as many others, can make the laser marking, thermally conductive compositions of the present disclosure appropriate for an array of applications.

In various aspects, the disclosed compositions can be appropriate for articles in the electrical field. The examples as follow include various articles that can utilize laser inscription or marking and are not intended to be limiting, but only illustrative. For example, the compositions disclosed herein can be used to create laser mark microdots exhibiting a variation in reflectivity compared to an unmarked substrate; to generate insignia, brand logos, text, barcodes, and/or images (such as photographic images) in the following exemplified articles: glazing parts such as automotive panels and lamp bezels in which the mark, including a watermark, can be introduced on the surface of the part; pharmaceutical or food packaging marks, including watermarks; electronic housings or screens in phones, computers, tablets, televisions, etc., where the mark, including a watermark, is on a surface or at an interface of two components, for example, where the first component comprises poly(methyl)methacrylate and the second component comprises polycarbonate; marking, including a watermark, on eyewear lenses and frames; an article with an image, including a photographic image, which is visible in positive or negative depending on whether the observer is viewing the image in transmission or reflection; contact recognition or Braille inscriptions; and marks, including a watermark, on the surface or subsurface at the interface of two layers within cards or tickets such as business cards, identification (ID) cards, customer cards, etc. In one example, a laser mark can be generated on the surface or at the interface of two layers (e.g., two components) wherein the entire card is transparent or exists as a window in an opaque card. The ID card can also comprise other layers. The other layers can include a metallic layer, a magnetic layer, a layer with angular metamerism properties, and combinations comprising at least one of the foregoing. The layers can be assembled via various processes including, but not limited to co-extrusion, co-lamination, etc.

In a further example, the ID can comprise a core layer (e.g., reflective thermoplastic layer), and a transparent film layer comprising the compositions disclosed herein (e.g., either a material having the capability of absorbing light at wavelengths of from 325 nm to 3370 nm, or from about 325 nm to about 3370 nm or a material comprising a light absorbing additive having the capability of absorbing light at wavelengths at 1064 nm, or about 1064 nm).

### Methods

In various aspects, the compositions can be prepared according to a variety of methods. The compositions of the present disclosure can be blended, compounded, or otherwise combined with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods can include, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the composition can be processed in an extruder at temperatures from 180° C. to 350° C., or from about 180° C. to about 350° C.

Aspect 1. A composition having laser marking properties comprising: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K, or from about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed 100 wt. %, and wherein all weight percent values are based on the total weight of the composition.

Aspect 2. A composition having laser marking properties comprising: from about 29.05 wt. % to about 90 wt. % of a polymer base resin; from about 9 wt. % to about 70 wt. % of a thermally conductive filler; and from about 0.05 wt. % to about 40 wt. % of a laser marking additive, wherein the composition exhibits a thermal conductive performance with through-plane thermal conductivity of from at least about 0.4 W/m·K to about 5 W/m·K, wherein the laser marking is visible, and wherein the combined weight percent value of all components does not exceed about 100 wt. %, and wherein all weight percent values are based on the total weight of the composition.

Aspect 3. A composition having laser marking properties consisting essentially of: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K , or at least about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed about 100 wt. %, and wherein all weight percent values are based on the total weight of the composition.

Aspect 4. A composition having laser marking properties consisting of: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K, or at least about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed about 100 wt. %, and wherein all weight percent values are based on the total weight of the composition.

Aspect 5. The composition of any of aspects 1-4, wherein the polymer base resin comprises a polyamide polymer.

Aspect 6. The composition of any of aspects 1-5, wherein the thermally conductive filler comprises aminosilane treated magnesium hydroxide.

Aspect 7. The composition of any of aspects 1-6, wherein the thermally conductive filler comprises zinc sulfide.

Aspect 8. The composition of any of aspects 1-7, wherein the laser marking additive comprises a copper containing metal oxide, a titanium containing metal oxide, a tin containing metal oxide, or a combination including at least one of the foregoing metal containing oxides.

Aspect 9. The composition of any of aspects 1-8, wherein the laser marking additive comprises a mixture of copper hydroxide phosphate, N,N-Hexan-1, 6-diylbis, and 1,3,5-triazine-2,4,6,(1H, 3H, 5H)-trione/1,3,5-triazine-2,4,6-triamine.

Aspect 10. The composition of any of aspects 1-9, wherein the laser marking additive comprises a heavy metal mixture oxide spinel.

Aspect 11. The composition of aspect 10, wherein the heavy metal mixture oxide spinal comprises a copper chromium oxide spinel.

Aspect 12. The composition of any of aspects 1-9, wherein the laser marking additive comprises copper.

Aspect 13. The composition of any of aspects 1-9, wherein the laser marking additive comprises a copper hydroxide phosphate, copper phosphate, copper sulfate, cuprous thiocyanate, or some combination thereof.

Aspect 14. The composition of any of aspects 1-9, wherein the laser marking additive comprises an organic metallic complex.

Aspect 15. The composition of aspect 14, wherein the metal complex comprises palladium.

Aspect 16. A molded article comprising: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K, or from at least about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed about 100 wt. %, and wherein all weight percent values are based on the total weight of the composition.

Aspect 17. A method of forming a composition having laser marking properties consisting of: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K, or from at least about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed about 100 wt. %, and wherein all weight percent values are based on the total weight of the composition.

Aspect 18. An article formed from the composition according to the method of aspect 15.

Aspect 19. A composition having laser marking properties comprising: from 29.05 wt. % to 90 wt. %, or from about 29.05 wt. % to about 90 wt. % of a polymer base resin; from 9 wt. % to 70 wt. %, or from about 9 wt. % to about 70 wt. % of a thermally conductive filler; and from 0.05 wt. % to 40 wt. %, or from about 0.05 wt. % to about 40 wt. % of a laser marking additive, wherein the composition exhibits a thermal conductive performance with through-plane thermal conductivity of from at least 0.4 W/m·K to 5 W/m·K, or from at least about 0.4 W/m·K to about 5 W/m·K, wherein an intensity variation of at least 40 is observed between a laser-marked region and a non-marked region of the composition, wherein the laser marking is visible, and wherein the combined weight percent value of all components does not exceed about 100 wt. %, and wherein all weight percent values are based on the total weight of the composition.

Aspect 20. The composition of aspect 19, wherein the laser marking additive is titanium dioxide

Aspect 21. A composition having laser marking properties comprising: from about 29.05 wt. % to about 90 wt. % of a polymer base resin; and from about 9 wt. % to about 70 wt. % of a thermally conductive filler, wherein the combined weight percent value of all components does not exceed about 100 wt. %, and wherein all weight percent values are based on the total weight of the composition; and further comprising from about 0.05 wt. % to about 40 wt. % of a laser marking additive.

Aspect 22. A method of forming a composition having laser marking properties comprising: from 29.05 wt. % to 90 wt. % of a polymer base resin; and from 9 wt. % to 70 wt. % of a thermally conductive filler, wherein the combined weight percent value of all components does not exceed 100 wt. %, and wherein all weight percent values are based on the total weight of the composition; further comprising from 0.05 wt. % to 40 wt. % of a laser marking additive, wherein the composition exhibits a thermal conductive performance with through-plane thermal conductivity of from at least 0.4 W/m·K to 5 W/m·K, and wherein the laser marking is visible; and wherein the laser marking additive is titanium dioxide.

### EXAMPLES

Detailed embodiments of the present disclosure are disclosed herein; it is to be understood that the disclosed embodiments are merely exemplary of the disclosure that may be embodied in various forms. Therefore, specific structural and functional details disclosed herein are not to be interpreted as limits, but merely as a basis for teaching one skilled in the art to employ the present disclosure. The specific examples below will enable the disclosure to be better understood. However, they are given merely by way of guidance and do not imply any limitation.

The following examples are provided to illustrate the compositions, processes, and properties of the present disclosure. The examples are merely illustrative and are not intended to limit the disclosure to the materials, conditions, or process parameters set forth therein.

### General Materials and Methods

The compositions as set forth in the Examples below were prepared from the components presented in Table 1.

TABLE 1
Components of the thermoplastic compositions.

| Item | Description | Name/Source |
|---|---|---|
| POLY1 | Nylon Polymer Base Resin | BASF |
| POLY2 | Nylon Polymer Base Resin | Rhodia |
| TC | Aminosilane treated | Martinswerk |
| | Magnesium hydroxide; | GmbH |
| | Thermally conductive filler | |
| COL | Zinc sulfide; Colorant | Sachtleben |
| LM1 | Fabulase 350; Laser marking | Budenheim |
| | filler | |
| LM2 | Titanium dioxide; Laser | Huntsmen |
| | marking pigment | |
| AO1 | Tris(2,4-di-tert-butylphenyl) | CIBA |
| | phosphite; Thermal stabilizer | |
| AO2 | 1-Ethylpiperidine | Fabulase 350, |
| | hypophosphite; Thermal | Budenheim |
| | stabilizer | |
| GS | Glass Spheres, PFG; filler | |

Formulations were prepared by melt extrusion. Components were compounded using a Toshiba Twin screw co-rotating twin screw extruder with the compounding settings set forth in Table 2.

TABLE 2
Compounding Settings

| Parameters | UOM | |
|---|---|---|
| Compounder Type | NONE | TEM-37BS |
| Barrel Size | mm | 1500 |
| Screw Design | NONE | L-3-3 |
| Die | mm | 430 |
| Zone 1 Temp | ° C. | 50 |
| Zone 2 Temp | ° C. | 150 |
| Zone 3 Temp | ° C. | 240 |
| Zone 4 Temp | ° C. | 240 |
| Zone 5 Temp | ° C. | 240 |
| Zone 6 Temp | ° C. | 240 |
| Zone 7 Temp | ° C. | 240 |
| Zone 8 Temp | ° C. | 240 |
| Zone 9 Temp | ° C. | 230 |
| Zone 10 Temp | ° C. | 230 |
| Zone 11 Temp | ° C. | 230 |
| Die Temp | ° C. | 240 |
| Screw speed | rpm | 300 |
| Throughput | kg/hr | 30 |
| Torque | NONE | 76 |
| Vacuum | MPa | −0.08 |
| Side Feeder 1 speed | rpm | 300 |
| Side Feeder 2 speed | rpm | 250 |
| Side Feeder 1 | NONE | barrel 7 |
| Side Feeder 2 | NONE | barrel 9 |
| Melt temperature | NONE | 258 |

The pellets obtained from extrusion were then injection molded using 150 T injection molding machine at a melt temperature of 280° C. and a mold temperature of 100° C. The injection molding parameters are set forth in Table 3 where kgf/cm² refers to a kilogram-force per square centimeter; s refers to seconds, ° C. refers to degrees Celcius, mm/s refers to millimeters per second, and rpm refers to revolutions per minute.

TABLE 3
Injection molding settings.

| Parameters | UOM | |
|---|---|---|
| Cnd: Pre-drying time | Hour | 4 |
| Cnd: Pre-drying temp | ° C. | 80 |
| Hopper temp | ° C. | 50 |
| Zone 1 temp | ° C. | 270 |
| Zone 2 temp | ° C. | 280 |
| Zone 3 temp | ° C. | 280 |
| Nozzle temp | ° C. | 280 |
| Mold temp | ° C. | 100 |
| Screw speed | rpm | 80 |
| Back pressure | kgf/cm² | 50 |
| Cooling time | s | 15 |
| Injection speed | mm/s | 60 |
| Holding pressure | kgf/cm² | 800 |
| Max. Injection pressure | kgf/cm² | 1000 |

Molded samples were then tested in accordance with the standards as follow. Unless specified to the contrary herein, all test standards are the most recent standard in effect at the time of filing this application.

Specific gravity (“SG”) was determined according to ASTM D792 on 63.5 mm by 12.7 mm by 3.2 mm bar specimens. The notched Izod impact (“NII”) test was carried out on 63.5 mm by 12.7 mm by 3.2 mm molded samples (bars) according to ASTM D256 at 23° C. Data units are joules per meter (J/m). The unnotched Izod impact (“UNII”) test was determined according to ASTM D4812 at 23° C. on sample bars having the dimensions 63.5 mm by 12.7 mm by 3.2 mm. Data units are Jim. Tensile properties were measured in accordance with ASTM D638 using Tensile type I bars (50 mm×13 mm). Tensile strength for either “at break” or “at yield” are reported in units of MPa. Flexural testing was determined according to ASTM D790 at 1.27 mm/min. Heat deflection temperature (HDT) was determined per ASTM D648 with flatwise specimen orientation with a 3.2 mm thick specimen at 1.82 MPa. Data are provided below in units of ° C. Thermal conductivity (TC) was measured according to ASTM E1461 on a Nanoflash LFA447 for a 80 mm by 10 mm by 3 mm plate cut into 10 mm by 10 mm by 3 mm square samples for through plane thermal conductivity measurements. In plane thermal conductivity was measured with 10 mm by 10 mm by 0.4 mm square samples cut from a molded 0.4 mm thick plate. Thermal diffusivity (α, square centimeters per second, cm²/s), specific heat (Cp, joules per gram Kelvin, J/g-K), and density (ρ, grams per cubic centimeter g/cm³, according to ASTM D792) are also observed. The three values provide the through plane thermal conductivity according to the equation κ=α(T) Cp(T) ρ(T).

Laser marking ability was determined according to the procedure described as follows. The image of a polymer background and each laser-marked region were taken using a KEYENCE VHX 500F camera. “Image Pro Plus” software was used to analyze each image. For calibration of an intensity standard, a white polymer specimen was used and defined as 255. A black polymer specimen was designated 0. Accordingly, a higher intensity value would indicate a brighter or lighter visual effect, while a lower intensity value corresponds to a darker effect. Using this calibration, the “intensity” of laser-marked and unmarked regions of a polymer sample was measured. The value of the intensity variation, or the differential, obtained between the intensity of a laser marked region and an unmarked region was used to evaluate the laser-marking quality of the sample. A higher differential corresponded to a higher laser marking effect. To simplify, an intensity differential of less than 20 was denoted as “weak;” an intensity differential between 20 and 40 was denoted as “marginal;” and an intensity differential of 40 or larger was denoted as “good.” Laser markings that could not be visibly ascertained readily were denoted as “fail” and represent that the sample showed no laser-marking ability.

Samples were prepared to assess performance of formulations comprising a copper hydroxide based laser marking additive, and other additives and are labeled Sample 1, Sample 2, and Sample 3 (S1-S3). Table 4 presents these thermally conductive formulations at differing loadings of the laser marking additive comprising a copper hydroxide mixture (LM1, Fabulase 350).

TABLE 4
Mechanical properties and thermal conductivity of
compositions with laser marking additives.

| | Sample 1 | Sample 2 | Sample 3 |
|---|---|---|---|
| Item Description | Wt. % | Wt. % | Wt. % |
| POLY1 | 39.65 | 39.15 | 38.65 |
| TC | 50 | 50 | 50 |
| LM1 | 0 | 0.5 | 1 |
| AO1 | 0.25 | 0.25 | 0.25 |
| AO2 | 0.1 | 0.1 | 0.1 |
| GS | 10 | 10 | 10 |
| Total | 100 | 100 | 100 |
| COL | 5 | 5 | 5 |
| Properties | S1 | S2 | S3 |
| Notched Izod Impact: | 42.3 | 38 | 38 |
| 23° C., 2 lbf/ft (J/m) | | | |
| Unnotched Izod Impact: 23° C., | 531 | 426 | 400 |
| 2 lbf/ft (J/m) | | | |
| Modulus of Elasticity (MPa) | 10384.4 | 10309.6 | 10188.8 |
| Tensile Stress at Break | 106.8 | 100.1 | 98.4 |
| (MPa) | | | |
| Elongation at Break (%) | 1.97 | 1.97 | 2.06 |
| Specific gravity | 1.68 | 1.68 | 1.69 |
| In plane Conductivity | 1.832 | 1.806 | 1.624 |
| (W/m · K) | | | |
| Through plane Conductivity | 1.278 | 1.231 | 1.125 |
| (W/m · K) | | | |

Table 4 presents the mechanical properties for three samples (S1-S3) at different loadings of the laser-marking filler LM1. Sample 1 had a 0 wt. % loading of the LM additive. Samples 2 and 3 had loadings of 0.5 wt. % and 1 wt. % respectively. The amount of LM1 filler added was maintained at or lower than 1% because LM1 (Fabulase 350) is a copper containing filler which can impart a green color to the polymer to which it is added. Loadings of LM1 greater than 1 wt. % can diminish the lighter coloring of the polymer. Samples S1-S3 exhibited values for in plane and through plane conductivity within ±0.25 W/m·K.

Table 5 presents the results from the laser-marking analysis for Samples S1-S3.

TABLE 5
Laser marking performance of thermally conductive samples
comprising a copper hydroxide based laser marking additive.

| | | | Sample 2 | | | Sample 3 | | |
|---|---|---|---|---|---|---|---|---|
| | Sample 1 | | | Intensity | | | Intensity | |
| lasered area | Intensity | Type | Intensity | Diff. | Type | Intensity | Diff | Type |
| background | 245.37 | 0 | 220.65 | 0 | 0 | 199.6 | 0 | 0 |
| 2 w; 40 KHZ; | 245.37 | fail | 182.99 | −37.66 | marginal | 164.42 | −35.18 | marginal |
| 2 m/s | | | | | | | | |
| 3 w; 40 KHZ; | 245.37 | fail | 176.52 | −44.13 | good | 160.15 | −39.45 | marginal |
| 2 m/s | | | | | | | | |
| 5 w; 40 KHZ; | 245.37 | fail | 175.03 | −45.62 | good | 169.91 | −29.69 | marginal |
| 2 m/s | | | | | | | | |
| 8 w; 40 KHZ; | 245.37 | fail | 177.78 | −42.87 | good | 156.75 | −42.85 | good |
| 2 m/s | | | | | | | | |
| 2 w; 70 KHZ; | 245.37 | fail | 196.69 | −23.96 | marginal | 170.7 | −28.9 | marginal |
| 2 m/s | | | | | | | | |
| 3 w; 70 KHZ; | 245.37 | fail | 187.82 | −32.83 | marginal | 159.89 | −39.71 | marginal |
| 2 m/s | | | | | | | | |
| 5 w; 70 KHZ; | 245.37 | fail | 169.15 | −51.5 | good | 157.39 | −42.21 | good |
| 2 m/s | | | | | | | | |
| 8 w; 70 KHZ; | 245.37 | fail | 171.11 | −49.54 | good | 155.98 | −43.62 | good |
| 2 m/s | | | | | | | | |
| 2 w; 100 KHZ; | 245.37 | fail | 209.63 | −11.02 | weak | 184.17 | −15.43 | weak |
| 2 m/s | | | | | | | | |
| 3 w; 100 KHZ; | 245.37 | fail | 201.98 | −18.67 | weak | 174.76 | −24.84 | marginal |
| 2 m/s | | | | | | | | |
| 5 w; 100 KHZ; | 245.37 | fail | 177.9 | −42.75 | good | 155.14 | −44.46 | good |
| 2 m/s | | | | | | | | |
| 8 w; 100 KHZ; | 245.37 | fail | 168.8 | −51.85 | good | 158.13 | −41.47 | good |
| 2 m/s | | | | | | | | |
| 10 w; 40 KHZ; | 245.37 | fail | 175.06 | −45.59 | good | 153.71 | −45.89 | good |
| 2 m/s | | | | | | | | |
| 3 w; 80 KHZ; | 245.37 | fail | 201.93 | −18.72 | weak | 175.49 | −24.11 | marginal |
| 4 m/s | | | | | | | | |
| 9 w; 80 KHZ; | 245.37 | fail | 170.54 | −50.11 | good | 156.2 | −43.4 | good |
| 4 m/s | | | | | | | | |
| 7 w; 100 KHZ; | 245.37 | fail | 174.41 | −46.24 | good | 152.7 | −46.9 | good |
| 4 m/s | | | | | | | | |
| 10 w; 70 KHZ; | 245.37 | fail | 175.57 | −45.08 | good | 151.9 | −47.7 | good |
| 2 m/s | | | | | | | | |
| 5 w; 80 KHZ; | 245.37 | fail | 181.49 | −39.16 | marginal | 156.96 | −42.64 | good |
| 4 m/s | | | | | | | | |
| 3 w; 100 KHZ; | 245.37 | fail | 206.54 | −14.11 | weak | 182.47 | −17.13 | weak |
| 4 m/s | | | | | | | | |
| 9 w; 100 KHZ; | 245.37 | fail | 169.24 | −51.41 | good | 156.21 | −43.39 | good |
| 4 m/s | | | | | | | | |
| 10 w; 100 KHZ; | 245.37 | fail | 175.55 | −45.1 | good | 153.63 | −45.97 | good |
| 2 m/s | | | | | | | | |
| 7 w; 80 KHZ; | 245.37 | fail | 171.85 | −48.8 | good | 156.27 | −43.33 | good |
| 4 m/s | | | | | | | | |
| 5 w; 100 KHZ; | 245.37 | fail | 186.94 | −33.71 | marginal | 160.01 | −39.59 | marginal |
| 4 m/s | | | | | | | | |
| 11 w; 100 KHZ; | 245.37 | fail | 171.91 | −48.74 | good | 160.68 | −38.92 | marginal |
| 4 m/s | | | | | | | | |

As shown in Table 5, Sample 1 exhibited no laser-marking function. At all regions of S1, the intensity measure was 245.37. Thus the intensity differential was 0, a “fail” type. As the loading of laser marking was increased to 0.5 wt. % in Sample 2, 15 of the 24 regions exhibited an intensity differential of greater than 40, a “good” type. At 1 wt. % loading of LM1 however, the number decreased to 13 of 24 regions having an intensity differential greater than 40, or “good.” It appeared that the addition of LM1 also darkened the background color of the sample composition, so the further increase of LM1 to a loading of 1 wt. % in Sample 3 did not improve the intensity differential overall.

The laser-marking function of formulations (S1-S3) comprising LM1 (Fabulase 350) were examined. Corresponding to the results presented in Table 5, Si showed no discernible intensity variation between marked and unmarked laser regions of the sample. Indeed, the entire sample appeared uniform in shade. Sample 2 showed 24 rectangular regions of a darker shade in the foreground (corresponding to the laser marked areas) compared to the lighter color throughout the background (corresponding to the unmarked) area of the sample. Sample 3 appeared similar to S2 with respect to the appearance of darkened regions. However, in S3, the background also appeared darker, thereby supporting the decreased intensity differential observed.

Samples were also prepared to assess performance of thermally conductive formulations comprising titanium dioxide as the laser marking additive. These samples are labeled Sample 4 through Sample 7 (S4-S7). Table 6 presents these thermally conductive formulations at differing loadings of titanium dioxide at 0 wt. % (S4), 3 wt. % (S5), 5 wt. % (S6), and 10 wt. % (S7).

TABLE 6
Mechanical properties and thermal conductivity of
formulations at various loadings of titanium dioxide.

| | Sample 4 | Sample 5 | Sample 6 | Sample 7 |
|---|---|---|---|---|
| Item | Wt. % | Wt. % | Wt. % | Wt. % |
| POLY1 | 21 | 21 | 21 | 21 |
| POLY2 | 15.65 | 15.65 | 15.65 | 15.65 |
| TC | 50 | 50 | 50 | 50 |
| AO1 | 0.25 | 0.25 | 0.25 | 0.25 |
| AO2 | 0.1 | 0.1 | 0.1 | 0.1 |
| GS | 13 | 13 | 13 | 13 |
| Total | 100 | 100 | 100 | 100 |
| LM2 | 0 | 3 | 5 | 10 |
| Properties | S4 | S5 | S6 | S7 |
| Notched Izod Impact: | 37.6 | 38.2 | 32.3 | 39.6 |
| 23° C., 2 lbf/ft (J/m) | | | | |
| Unnotched Izod Impact: | 520 | 409 | 373 | 382 |
| 23° C., 2 lbf/ft (J/m) | | | | |
| Specific gravity | 1.680 | 1.705 | 1.723 | 1.757 |
| Through plane | 1.409 | 1.495 | 1.387 | 1.521 |
| Conductivity (W/m · K) | | | | |
| In plane Conductivity | 1.887 | 2.054 | 1.79 | 2.028 |
| (W/m · K) | | | | |
| Modulus of Elasticity | 11728.8 | 11114.6 | 11157.4 | 11141.4 |
| (MPa) | | | | |
| Tensile Stress at Break | 115.4 | 98 | 97.6 | 93.9 |
| (MPa) | | | | |
| Elongation at Break (%) | 1.97 | 1.6 | 1.59 | 1.43 |

As shown in Table 6, Samples 4 through 7 exhibited through plane and in plane conductivities within ±0.30 W/m·K. Furthermore, S4-S7 all exhibited a thermal conductive performance with through plane thermal conductivity greater than 1.3 W/m·K.

The laser-marking function of formulations Samples S4-S7 were also observed. Sample 4 showed no discernible variation between marked and unmarked regions. As the loading of titanium dioxide (LM2) was increased, the variation in shade between marked and unmarked regions became more readily apparent for S6 and S7. That is, there was a more apparent contrast in the shade for samples S6 and S7. Titanium dioxide was characterized as a white laser-marking pigment. Significantly higher loading of LM2 was needed to establish a significant intensity differential in the samples (S7 at 10 wt. %). Accordingly, LM1 (copper hydroxide LM1) was a more efficient additive at lower percent loading.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While aspects of the present disclosure can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

It is also to be understood that the terminology used herein is for the purpose of describing particular aspects only and is not intended to be limiting. As used in the specification and in the claims, the term “comprising” may include the aspects “consisting of” and “consisting essentially of” Unless defined otherwise, all technical and scientific terms used herein have the same meaning as commonly understood by one of ordinary skill in the art to which this disclosure belongs.

As used in the specification and the appended claims, the singular forms “a,” “an” and “the” include plural referents unless the context clearly dictates otherwise. Thus, for example, reference to “a monomer” can include mixtures of two or more such monomers. Ranges can be expressed herein as from “about ” one particular value, and/or to “about ” another particular value. When such a range is expressed, another aspect includes from the one particular value and/or to the other particular value. Similarly, when values are expressed as approximations, by use of the antecedent “about,” it will be understood that the particular value forms another aspect. A value modified by a term or terms, such as “about ” and “substantially,” is intended to include the degree of error associated with measurement of the particular quantity based upon the equipment available at the time of filing this application. It will be further understood that the endpoints of each of the ranges are significant both in relation to the other endpoint, and independently of the other endpoint. It is also understood that there are a number of values disclosed herein, and that each value is also herein disclosed as “about ” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed. In a further example, the expression “from about 2 to about 4” also discloses the range “from 2 to 4.” The term “about ” can refer to plus or minus 10% of the indicated number. Moreover, “about 10%” can indicate a range of 9% to 11%, and “about 1” may mean from 0.9-1.1. Other meanings of “about ” can be apparent from the context, such as rounding off, so, for example “about 1” may also mean from 0.5 to 1.4.

As used herein, the terms “optional” or “optionally” mean that the subsequently described event, condition, component, or circumstance may or may not occur, and that the description includes instances where said event or circumstance occurs and instances where it does not.

Disclosed are component materials to be used to prepare disclosed compositions as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Compounds disclosed herein are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

As used herein, the terms “weight average molecular weight” or “Mw” can be used interchangeably, and are defined by the formula:

$$Mw = \frac{\sum {N}_{i} {M}_{i}^{2}}{\sum {N}_{i} {M}_{i}} ,$$

where Mi is the molecular weight of a chain and Ni is the number of chains of that molecular weight. Compared to Mn, Mw takes into account the molecular weight of a given chain in determining contributions to the molecular weight average. Thus, the greater the molecular weight of a given chain, the more the chain contributes to the Mw. It is to be understood that as used herein, Mw can be measured by gel permeation chromatography. In some cases, Mw can be measured by gel permeation chromatography and calibrated with known standards, such as, for example polystyrene standards or polycarbonate standards. As an example, a polycarbonate of the present disclosure can have a weight average molecular weight of greater than 5,000 Daltons, or greater than about 5,000 Daltons, based on PS standards. As a further example, the polycarbonate can have an Mw of from 20,000 to 100,000 Daltons, or from about 20,000 to about 100,000 Daltons.

1. A composition having laser marking properties comprising:
from 29.05 wt. % to 90 wt. % of a polymer base resin;
from 9 wt. % to 70 wt. % of a thermally conductive filler; and
from 0.05 wt. % to 40 wt. % of a laser marking additive,
wherein the composition exhibits a thermal conductive performance with through-plane thermal conductivity of from at least 0.4 W/m·K to 5 W/m·K,
wherein the laser marking is visible, and
wherein the combined weight percent value of all components does not exceed 100 wt. %, and wherein all weight percent values are based on the total weight of the composition.

2. The composition of claim 1, wherein an intensity variation of at least 40 is observed between a laser marked region and a non marked region of the composition.

3. The composition of claim 1, wherein the polymer base resin comprises a polyamide polymer.

4. The composition of claim 1, wherein the thermally conductive filler comprises aminosilane treated magnesium hydroxide or zinc sulfide or a combination thereof.

5. The composition of claim 1, wherein the laser marking additive comprises a copper containing metal oxide, a titanium containing metal oxide, a tin containing metal oxide, or a combination including at least one of the foregoing metal containing oxides.

6. The composition of claim 1, wherein the laser marking additive comprises a mixture of copper hydroxide phosphate, N,N-Hexan-1, 6-diylbis, and 1,3,5-triazine-2,4,6,(1H, 3H, 5H)-trione/1,3,5-triazine-2,4,6-triamine.

7. The composition of claim 1, wherein the laser marking additive comprises a heavy metal mixture oxide spinel.

8. The composition of claim 7, wherein the heavy metal mixture oxide spinal comprises a copper chromium oxide spinel.

9. The composition of claim 1, wherein the laser marking additive comprises copper.

10. The composition of claim 9, wherein the laser marking additive comprises a copper hydroxide phosphate, copper phosphate, copper sulfate, cuprous thiocyanate, or some combination thereof.

11. The composition of claim 1, wherein the laser marking additive comprises an organic metallic complex.

12. The composition of claim 11, wherein the metal complex comprises palladium.

13. A molded article formed from the composition of claim 1.

14. A method of forming a composition according to claim 1.

15. A method of forming a composition having laser marking properties comprising:
from 29.05 wt. % to 90 wt. % of a polymer base resin; and
from 9 wt. % to 70 wt. % of a thermally conductive filler, wherein the combined weight percent value of all components does not exceed 100 wt. %, and wherein all weight percent values are based on the total weight of the composition;
further comprising from 0.05 wt. % to 40 wt. % of a laser marking additive, wherein the composition exhibits a thermal conductive performance with through-plane thermal conductivity of from at least 0.4 W/m·K to 5 W/m·K, and wherein the laser marking is visible;
and wherein the laser marking additive is titanium dioxide.

16. A composition having laser marking properties comprising:
from 29.05 wt. % to 70 wt. % of a polyamide polymer resin;
from 9 wt. % to 60 wt. % of a thermally conductive filler; and
from 0.05 wt. % to 30 wt. % of a laser marking additive,
wherein the composition exhibits a thermal conductive performance with through-plane thermal conductivity of from at least 0.4 W/m·K to 5 W/m·K,
wherein the laser marking is visible, and
wherein the combined weight percent value of all components does not exceed 100 wt. %, and wherein all weight percent values are based on the total weight of the composition

17. The composition of claim 16, wherein the laser marking additive comprises a mixture of copper hydroxide phosphate, N,N-Hexan-1, 6-diylbis, and 1,3,5-triazine-2,4,6,(1H, 3H, 5H)-trione/1,3,5-triazine-2,4,6-triamine.

18. The composition of claim 16, wherein the laser marking additive comprises a heavy metal mixture oxide spinel.

19. The composition of claim 16, wherein the heavy metal mixture oxide spinal comprises a copper chromium oxide spinel.

20. The composition of claim 16, wherein the laser marking additive comprises an organic metallic complex.
